(19) United States
(12) Patent Application Publication
(10) Pub. No.: US 2011/0241899 A1
(43) Pub. Date: Oct. 6, 2011

(54) Targeted Enforcement For Road User Charging

(75) Inventors: Todd M. Appel, Amstelveen (NL); Duncan A. Ashby, Surbiton (GB); So Yeon Chun, Atlanta, GA (US); Milind R. Naphade, Fishkill, NY (US); Richard J. Nash, Portsmouth (GB); Anshul Sheopuri, Hartsdale, NY (US); Anders Thornqvist, Sollentuna (SE); Martin Vuyk, Nederhorst den Berg (NL)

(73) Assignee: International Business Machines Corporation, Armonk, NY (US)

(21) Appl. No.: 12/752,578

(22) Filed: Apr. 1, 2010

(51) Int. Cl. G08G 1/01

(52) U.S. Cl. 340/933

(57) ABSTRACT

A method is disclosed that includes, for a set of passages of a vehicle, where each passage is associated with at least one confidence level, applying at least one heuristic to confidence levels corresponding to the set to determine at least one score. The method also includes performing the applying at least one heuristic for a number of sets of passages of a number of vehicles and selecting a number of the sets based on their associated at least one scores. The method additionally includes outputting identifications corresponding to each of the selected sets. Apparatus and computer readable media are also disclosed.

### BACKGROUND

This invention relates generally to systems that communicate with units in vehicles for road user charging purposes and, more specifically, relates to targeted enforcement for road user charging.

In road user charging systems, an on-board unit (OBU) is placed in each vehicle to be charged. The charging is based on, e.g., distance traveled, zone, time of travel, and the like. For instance, a goal for this type of system may be to managing traffic congestion by setting higher costs for travel on certain roads or in certain areas. Thus, roads or areas that are typically congested have a higher cost for travel. These systems also may include variable pricing based on travel during certain times of the day. That is, it is more expensive to travel during peak hours. These systems also provide taxes for use of the roads.

In many of these systems, the OBU keeps track of locations, times at those locations, and the like. At certain times, the OBU reports this data to a central location, called the “back office.” The back office then bills the user based, e.g., on a road use schedule.

Because these systems are becoming more widespread, abusers of the systems are also becoming more prevalent. For example, software is available to fake user location: information can be stored in the OBU indicating that the vehicle is located in a low cost zone, when actually the vehicle is located in a high cost zone. Additionally, the OBU may also be tampered with, switched off, or put into different vehicles.

Gantries typically serve as enforcement mechanisms. For example, a gantry observes a vehicle being in a high price zone but the vehicle claims to be in a low price zone at the observation time. As another example, a gantry uses automatic number plate recognition (ANPR) to determine that a license plate number viewed on a vehicle is different from a license place associated with the OBU for the vehicle. Such possible evidence of abuse is typically sent to the back office for further analysis and enforcement.

At the back office, this evidence has to be analyzed further, because the gantries and OBUs are not infallible when making observations such as those previously described. For instance, the gantry may make an incorrect ANPR of a license plate. While these observations have a low error rate, an error rate of only a few percent will cause a large volume of data when that error rate is multiplied by many gantries and hundreds or thousands of vehicles passing through the gantries on a daily basis. Currently, this evidence is manually examined, which can be laborious.

What is needed, therefore, are techniques for reducing the amount of manual labor for examining evidence of possible abuses of road user-charging systems and for improving upon errors in observations of gantries.

### SUMMARY

In an exemplary embodiment, a method is disclosed that includes for a set of passages of a vehicle, where each passage is associated with at least one confidence level, applying at least one heuristic to confidence levels corresponding to the set to determine at least one score. The method also includes performing the applying at least one heuristic for a number of sets of passages of a number of vehicles and selecting a number of the sets based on their associated at least one scores. The method additionally includes outputting identifications corresponding to each of the selected sets.

In another exemplary embodiment, an apparatus is disclosed that includes at least one memory comprising instructions and at least one processor operatively coupled to the at least one memory, the at least one processor configured by the instructions to cause the apparatus to perform operations including for a set of passages of a vehicle, where each passage is associated with at least one confidence level, applying at least one heuristic to confidence levels corresponding to the set to determine at least one score. The operations also include performing the applying at least one heuristic for a number of sets of passages of a number of vehicles and selecting a number of the sets based on their associated at least one scores. The operations further include outputting identifications corresponding to each of the selected sets.

In another exemplary embodiment, a computer readable medium is disclosed that tangibly embodies a program of machine-readable instructions executable by a digital processing apparatus to perform operations including for a set of passages of a vehicle, where each passage is associated with at least one confidence level, applying at least one heuristic to confidence levels corresponding to the set to determine at least one score. The operations include performing the applying at least one heuristic for a number of sets of passages of a number of vehicles and selecting a number of the sets based on their associated at least one scores. The operations further include outputting identifications corresponding to each of the selected sets.

### BRIEF DESCRIPTION OF THE SEVERAL VIEWS OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of an exemplary road user charging system suitable for use with the invention;

FIG. 2 is a block diagram illustrating interactions between an exemplary road user charging system, vehicles, and enforcement in accordance with an exemplary embodiment of the invention;

FIG. 3 is a block diagram of an exemplary back office processing apparatus;

FIG. 4 is a portion of a spreadsheet showing a number of heuristics applied to sets of passages through gantries for a number of vehicles, where each passage has an associated confidence level;

FIG. 5 is a portion of a spreadsheet showing a single heuristic applied to sets of passages through gantries for a number of vehicles, where each passage has an associated confidence level, and where a ranking has been performed based on scores;

FIG. 6 shows a portion of a ranked list of vehicles; and

FIG. 7 is a flowchart of a method for performing targeted enforcement for road user charging.

### DETAILED DESCRIPTION

As previously described, all evidence including vehicle information sent to the back office in a road user charging system is not due to system abuse. Errors in license plate recognition (which may amount to around four to six percent error) may result in targeting of innocent individuals. Furthermore, there can be a substantial amount of labor involved in examining evidence of possible abuses of road user charging systems. In order to improve upon these problems and therefore improve enforcement, aspects of the invention provide targeted enforcement for road user charging. In an exemplary embodiment, lists are developed for targeted enforcement based on consistency in OBU data and Gantry data. In particular, one or more heuristics are applied to a multitude of sets of passages, each set corresponding to a number of passages made by a vehicle through one or more gantries. Each passage is associated with a confidence level. The application of the one or more heuristics results in one more scores. The scores are then compared, generally by ranking the scores, to determine which users (e.g., identified by vehicle identifications) are potentially abusing the road user charging system. Such ranking may be output, in an exemplary embodiment, in a ranked vehicle list. Enforcement may be performed using the ranked vehicle list. If it is subsequently determined that innocent users are targeted, the heuristics may be modified.

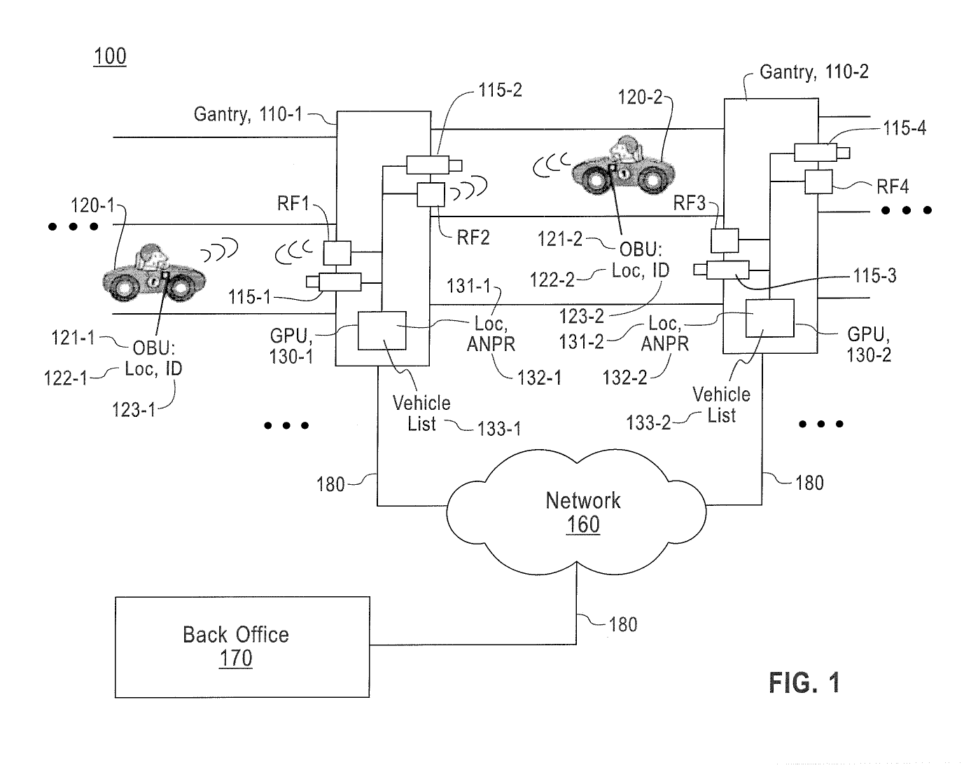

Turning now to FIG. 1, this figure shows a block diagram of an exemplary road user charging system 100 suitable for use with the invention. The road user charging system 100 includes N gantries, of which only gantries 110-1 and 110-2 are shown. The gantries 110 are connected to the back office 170 through a radio frequency (RF) or wired network 160 and wireless or wired network links 180. Gantry 110-1 includes (in this example) two cameras 115-1 and 115-2, two radio frequency communication systems (RF1 and RF2) and a gantry processing unit (GPU) 130-1. Similarly, gantry 110-2 includes (in this example) two cameras 115-3 and 115-4, two radio frequency communication systems (RF3 and RF4) and a GPU 130-2. The gantry 110-1 is shown in RF communications with vehicles 120-1 and 120-2.

Each vehicle 120-1, 120-2 has an OBU 121-1, 121-2, respectively. The OBU 121-1 includes a location 122-1 and an identifier (ID) 123-1. Similarly, the OBU 121-2 includes a location 122-2 and an ID 123-2. The IDs 123 may be any item that uniquely identifies the corresponding OBU 121. Locations 122-1 and 122-2 are not addressed herein but are included for completeness.

Each GPU 130 processes information from its associated cameras 115 and RF communication systems RF1-RF4 and produces an associated and respective ANPR value 132-1 and 132-2. If the ANPR value 132-1 does not match the license plate value (not shown) associated with the ID 123-1, the GPU 130-1 will include a certain amount of information to send back to the back office 170 in vehicle list 133-1. Similarly, if the ANPR value 132-2 does not match the license plate value (not shown) associated with an ID 123, the GPU 130-2 will include a certain amount of information to send back to the back office 170 in vehicle list 133-2.

The vehicle lists 133 may contain a variety of different information, based on the policies of the road user charging system 100. For instance, if a vehicle 120 or its associated OBU 121 passes the ANPR observation, little or no information might be placed by the GPU 130 into the vehicle lists 133. This is based primarily on privacy concerns. On the other hand, if a vehicle 120 or its associated OBU 121 fails the ANPR observation, a large set of information might be placed by the GPU 130 into the vehicle lists 133 so that the back office 170 can match the vehicle 120 with the OBU 121 (and a corresponding user).

Thus, each vehicle list 133 may contain information about all vehicles 120 or only those vehicles 120 that fail any tests. Typically, the latter will be the case, such that only information related to suspect vehicles 120 that fail an ANPR observation will be placed into vehicle lists 133-1, 133-2. The vehicles 120 that fail an ANPR observation are “flagged” vehicles and a list containing only information related to flagged vehicles is called a flagged vehicle list herein.

One item of importance not shown in FIG. 1 is a confidence level. Confidence levels are described and shown below. Depending on how the road user charging system 100 is implemented, the gantries 110 may calculate a confidence level, or another element, such as the back office 170, may calculate the confidence level. For ease of reference, it will be assumed throughout the rest of this document that the confidence levels are calculated at the gantries 110.

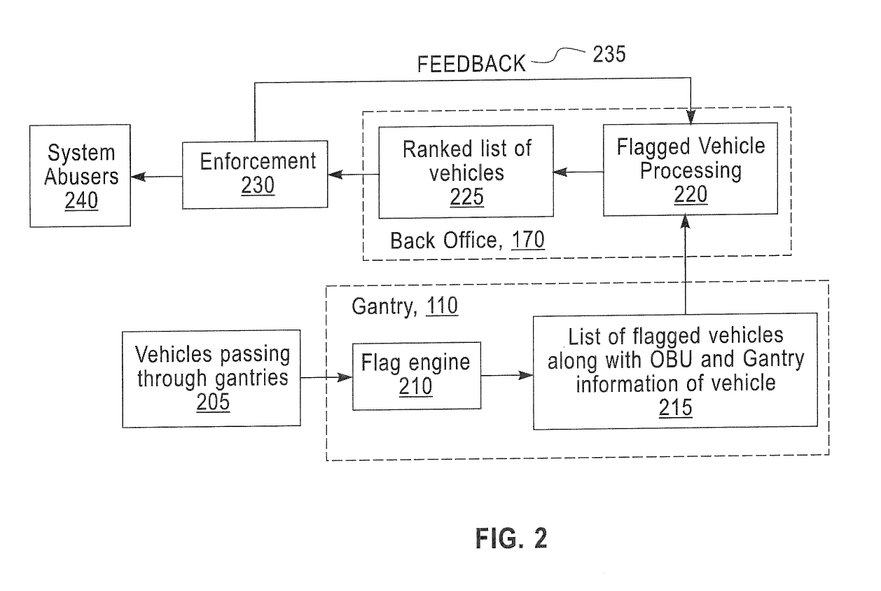

Referring now to FIG. 2, a block diagram is shown that illustrates interactions between an exemplary road user charging system, vehicles, and enforcement in accordance with an exemplary embodiment of the invention. In Block 205, vehicles pass though gantries 110. In this example, each gantry includes a flag engine 210 (e.g., executed by an associated GPU 130), and flag engine 210 creates a flagged vehicle list 215, which contains a list of flagged vehicles along with OBU 121 and gantry 110 information. In this example, flagged vehicle list 215 is vehicle list 133. Or, put another way, the vehicle list 133 only contains information related to flagged vehicles and is called the flagged vehicle list 215.

In Block 220, the back office 170 performs flagged vehicle processing. The flagged vehicle processing results in a ranked list of vehicles 225. In Block 230, enforcement occurs using the list of flagged vehicle and operates on (potential) system abusers 240. If innocent users are indicated as being potential system abusers 240 by the ranked list of vehicles, feedback 235 is performed, which may result in adjustments to the heuristics being used, as described in more detail below.

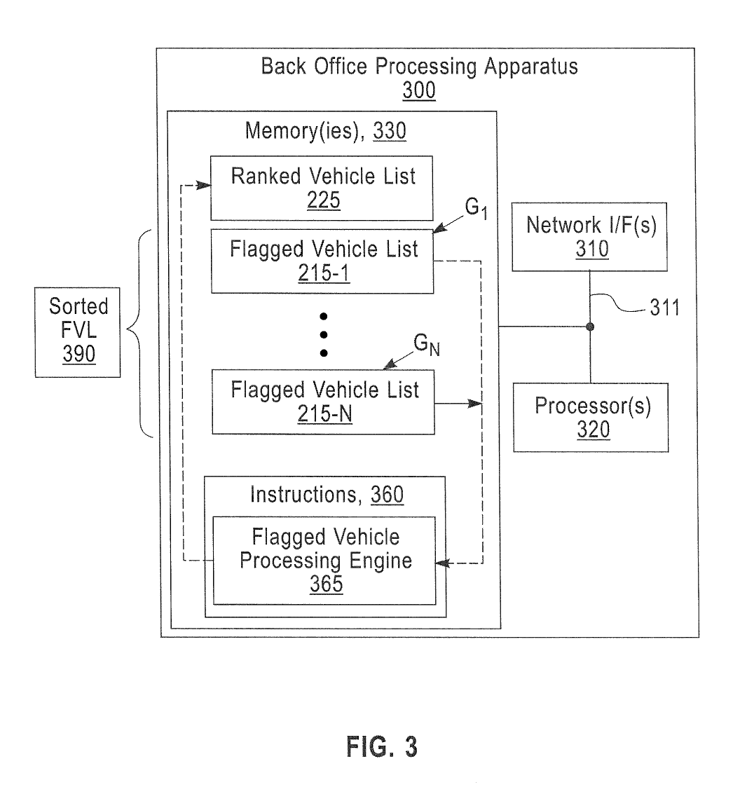

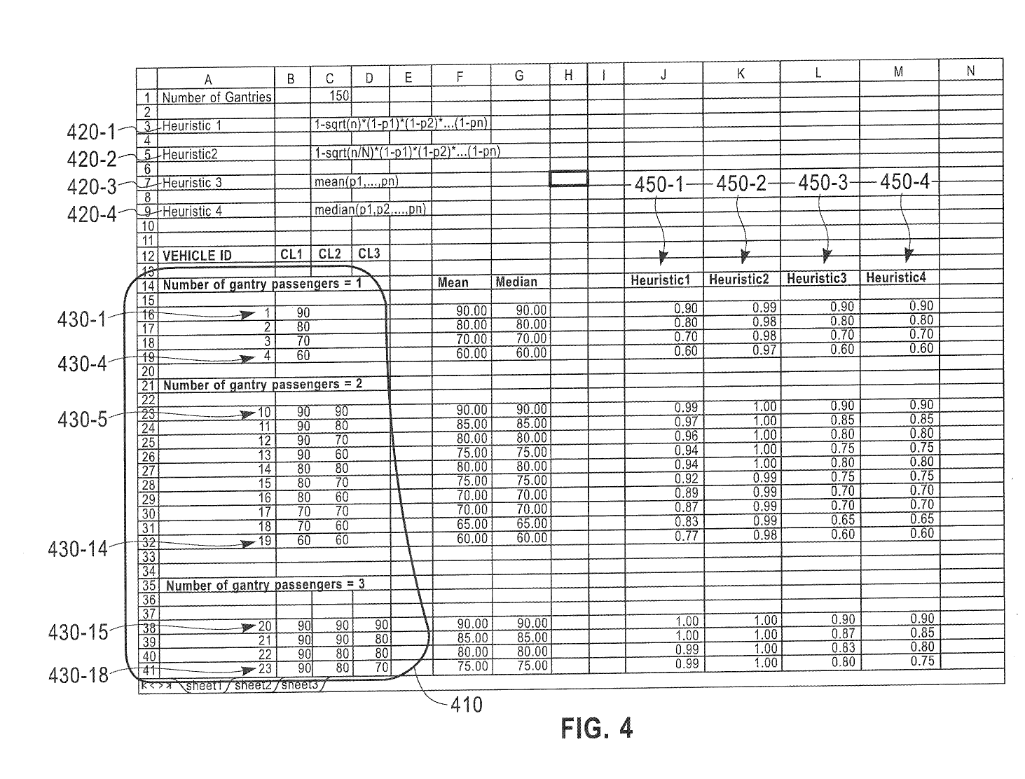

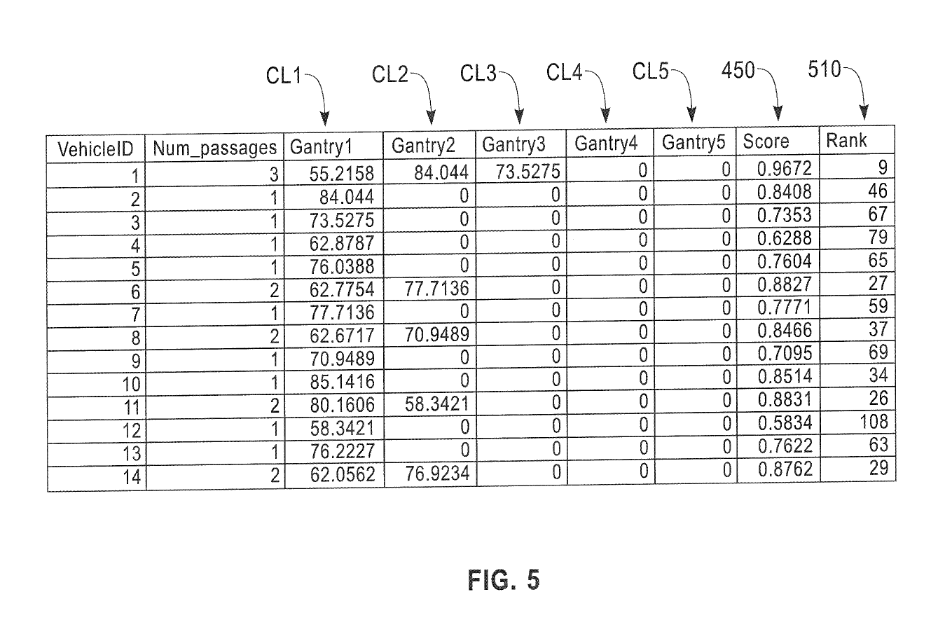

Turning now to FIG. 3, this figure shows a block diagram of an exemplary back office processing apparatus 300 (e.g., a digital processing apparatus) that would be implemented in back office 170. The back office processing apparatus comprises one or more network interfaces 310, one or more processors 320, and one or more memories 330, all connected through one or more buses 311. The one or more memories 330 include instructions 360, including flagged vehicle processing engine 365, which cause the apparatus 300 to carry out the operations disclosed herein for targeted enforcement for road user charging, when the instructions are executed by the one or more processors 320. The one or more memories 330 contain flagged vehicle lists 215-1 through 215-N from gantries G₁ through G_{N}, respectively. In one example, the flagged vehicle processing engine 365 is configured to examine the information in the flagged vehicle lists 215 and to organize these into sets of passages for individual vehicles through one or more gantries, illustrated by sorted flagged vehicle list (FVL) 390. The sorted flagged vehicle list 390 is shown in more detail in FIGS. 4 and 5. However, another option is some other entity, prior to the back office 170 or in the back office 170 operates to examine the information in the flagged vehicle lists 215 and to organize these into sets of passages for individual vehicles through one or more gantries, as in sorted flagged vehicle list (FVL) 390.

The flagged vehicle processing engine 365 operates on the sorted flagged vehicle list 390 to create a ranked vehicle list 225. The operations taken by flagged vehicle processing engine 365 are now explained in more detail.

Referring now to FIG. 4, this figure shows a portion of a spreadsheet showing a number of heuristics applied to sets of passages through gantries for a number of vehicles, where each passage has an associated confidence level. Shown in FIG. 4 is a portion 410 of sorted flagged vehicle list 390. Also shown are sets 430-1 through 430-18 of passages through gantries, each set 430 corresponding to passages by a single vehicle (identified by the “vehicle ID”) through one or more gantries. For example, each set 430-1 through 430-4 corresponds to a single passage through a single gantry of a vehicle having one of the vehicle IDs of 1 (one) through 4 (four) respectively. Each of the single gantries listed in FIG. 1 may be any of the N gantries 110. Each set 430-5 through 430-14 corresponds to passages through two gantries 110 by a vehicle having one of the vehicle IDs 10 through 19. Each set 430-15 through 430-18 corresponds to passages through three gantries 110 by a vehicle having one of the vehicle IDs 20 through 23. It is noted that the gantries shown in FIG. 4 could be the same gantry 110 or a different gantry. For example, set 430-5 could be a vehicle passing through a particular gantry twice or passing through two different gantries.

Each passage through a gantry is associated with a corresponding confidence level, CL1, CL2, or CL3. The confidence levels in this example are a determination by a gantry as to the probability that the ANPR determination for the vehicle is correct. In this example, a 100 would indicate a very high probability that the ANPR determination is correct and a zero would indicate a very low probability that the ANPR determination is correct (i.e., a high probability that the ANPR determination is incorrect). It should be noted that the scale may also be reversed, so that 100 indicates a very low probability that the ANPR determination is correct (i.e., a high probability that the ANPR determination is incorrect).

This example shows heuristics 420-1 through 420-4 being applied to the sets of passages and their corresponding confidence levels. Application of the heuristics 420-1 through 420-4 results in scores 450-1 through 450-4, respectively. In this example, the heuristic 420-1 is the following:

1−\sqrt{n}(1−p1)(1−p2) . . . (1−pn),

where n is the number of passages for a particular set, p1 is the confidence level for passage 1 (one), p2 is the confidence level for passage 2 (two), . . . , and pn is the confidence level for passage n.

Heuristic 420-2 is the following:

1−\sqrt{n/N}(1−p1)(1−p2) . . . (1−pn),

where N is the total number of passages.

Heuristic 420-3 is the following:

mean(p1, p2, . . . , pn).

Heuristic 420-4 is the following:

median(p1, p2, . . . , pn).

Certain scores 450 can then be selected based (in this example) on the highest values for the scores 450. Typically, this is performed by ranking the scores and then selecting the highest ranking scores (e.g., a number of highest ranking scores or scores above a predetermined score).

The example of FIG. 4 shows four different heuristics being used and applied to determine which heuristic 420 is the “best” for the road user charging system 100 being examined. In other words, which heuristic 420 has the lowest rate of errors found during enforcement. It should be noted that multiple heuristics may be combined: for example, a score for heuristic 420-1 could be added to the score for heuristic 420-1 and the result divided by two.

Referring now to FIG. 5, this figure shows a portion of a spreadsheet showing a single of heuristic (heuristic 420-1 above) applied to sets of passages through gantries for a number of vehicles, where each passage has an associated confidence level, and where a ranking has been performed based on scores. In this example, passages are indicated per gantry, but the gantries are not necessarily different gantries per set. In other words, for the vehicle with vehicle ID of 1 (one), which made three passages through three gantries, Gantry1 could be the same as Gantry3. As before, each passage is associated with a confidence level CL1 through CL5. In this case, scores 450 are shown along with an equivalent rank 510.

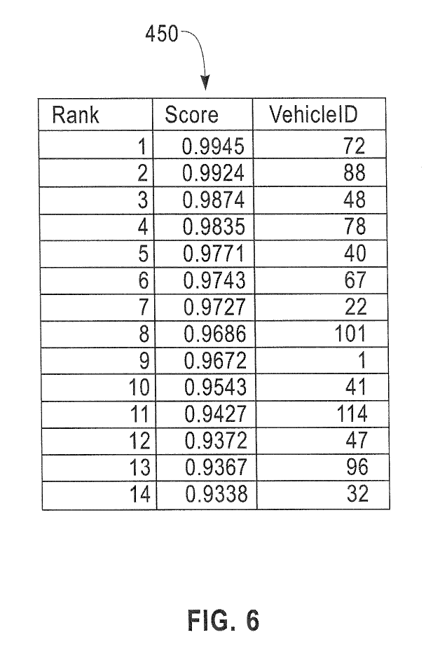

FIG. 6 shows a portion 610 of a ranked list 225 of vehicles. In this example, the highest score 450 has the highest rank, although it could also be true that the lowest score 450 could have the highest rank, depending on how the system creating the confidence levels is designed. In the portion 610 of ranked list 225, the vehicle ID is the output that is used for subsequent enforcement. It should also be noted that the vehicle ID may be a “fake” ID if privacy concerns are an issue: the vehicle ID given to the flagged vehicle processing engine 365 can be an ID that is unique but does not identify the user. Enforcement 230 (or another entity) can then map the vehicle ID of FIG. 6 back to the user IDs.

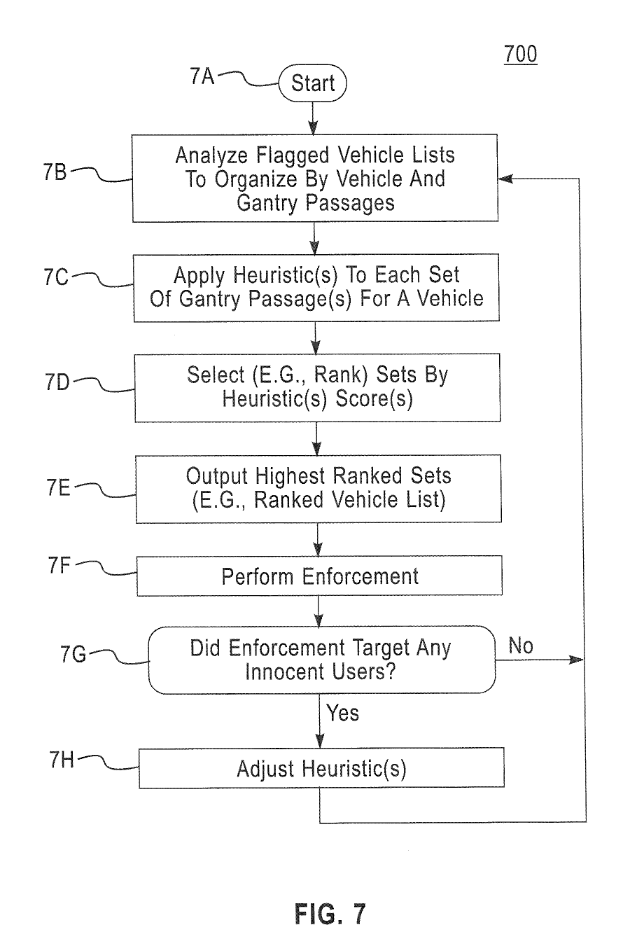

Referring to FIG. 7 and other appropriate figures, this figure shows a flowchart of a method 700 for performing targeted enforcement for road user charging. Method 700 may be performed, at least in part, by a digital processing apparatus such as the apparatus shown in FIG. 3. In Block 7A, the method begins. In Block 7B, flagged vehicle lists are analyzed to organize by gantry passages by vehicle. For instance, the flagged vehicle lists 215 shown, e.g., in FIG. 3 from each of the N gantries 110 are organized into passages for each vehicle, as shown in portion 410 of sorted flagged vehicle list 390 of FIG. 4. The actions in Block 7B are typically performed by some entity (not shown) of the back office 170, although the flagged vehicle processing engine 365 may also perform these actions. It is noted that the example of FIG. 7 is based on the premise that only flagged vehicles are used for processing. However, as previously discussed, the method 700 may also operate on vehicle lists that include data from both flagged observations (e.g., a failure of ANPR) and also non-flagged observations (e.g., passing ANPR).

In Block 7C, heuristic(s) are applied to each set 430 of gantry passage(s) for a vehicle for each of the sets 430 of gantry passages and corresponding vehicles. Block 7C results in scores 450. Block 7C may be performed by the flagged vehicle processing engine 365. In Block 7D, sets 430 of passages are selected based on heuristic(s) scores. Such sets 430 are typically selected by creating a ranked vehicle list 610. Such a ranked vehicle list 610 can include a predetermined number of sets based on the sets 430 having highest ranked (in one embodiment) scores 450 or sets 430 having scores 450 above (for instance) a predetermined score. Block 7E may be performed by the flagged vehicle processing engine 365.

In Block 7F, enforcement is performed. Such enforcement is typically performed by personnel managing the road user charging system 100, such as by mailing a letter indicating possible abuse to a user. If the enforcement targeted any innocent users (Block 76=YES), then the heuristic(s) may be adjusted (Block 7H) through a technique such as using a different heuristic that does not select the innocent user (e.g., because an associated score for the user would not be in the ranked vehicle list 225). Additionally, scores from heuristics may be combined (thereby combining two heuristics into a single heuristic) to avoid selecting the user.

If the enforcement did not target any innocent users (Block 7G=NO) or after heuristic(s) are adjusted (Block 7H), method 700 continues in Block 7B, when new flagged vehicle lists are analyzed to organize these lists by gantry passages and by vehicles.

As should be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” It is noted that “an entirely software embodiment” would be implemented by, e.g., a digital processing apparatus such as that shown in FIG. 3. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device such as a digital processing apparatus.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or assembly language or similar programming languages. Such computer program code may also include code for field-programmable gate arrays, such as VHDL (Very-high-speed integrated circuit Hardware Description Language).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. A method, comprising:
for a set of passages of a vehicle, where each passage is associated with at least one confidence level, applying at least one heuristic to confidence levels corresponding to the set to determine at least one score;
performing the applying at least one heuristic for a plurality of sets of passages of a plurality of vehicles;
selecting a number of the sets based on their associated at least one scores; and
outputting identifications corresponding to each of the selected sets.

2. The method of claim 1, wherein at least one passage for a vehicle is a passage through a gantry.

3. The method of claim 1, wherein the at least one confidence level for at least one of the passage corresponds to an automatic number plate recognition observation.

4. The method of claim 1, wherein selecting a number further comprises ranking each of the sets based upon corresponding at least one scores.

5. The method of claim 4, wherein selecting further comprises selecting those sets having corresponding at least one scores meeting a predetermined criterion.

6. The method of claim 1, wherein the at least one heuristic comprises at least one of 1−\sqrt{n}(1−p1)(1−p2) . . . (1−pn), 1−\sqrt{n/N}(1−p1)(1−p2) . . . (1−pn), mean(p1, p2, . . . , pn), or median(p1, p2, . . . , pn), where n is a number of passages for a particular set, p1 is a confidence level for passage 1, p2 is the confidence level for passage 2, . . . , and pn is a confidence level for passage n, and N is the total number of passages.

7. The method of claim 1, wherein applying at least one heuristic further comprises applying a plurality of heuristics to confidence levels corresponding to the set to determine at least one score.

8. The method of claim 1, wherein the identifications identify associated ones of the vehicles.

9. An apparatus, comprising:
at least one memory comprising instructions; and
at least one processor operatively coupled to the at least one memory, the at least one processor configured by the instructions to cause the apparatus to perform operations comprising:
for a set of passages of a vehicle, where each passage is associated with at least one confidence level, applying at least one heuristic to confidence levels corresponding to the set to determine at least one score;
performing the applying at least one heuristic for a plurality of sets of passages of a plurality of vehicles;
selecting a number of the sets based on their associated at least one scores; and
outputting identifications corresponding to each of the selected sets.

10. The apparatus of claim 9, wherein at least one passage for a vehicle is a passage through a gantry.

11. The apparatus of claim 9, wherein the at least one confidence level for at least one of the passage corresponds to an automatic number plate recognition observation.

12. The apparatus of claim 9, wherein selecting a number further comprises ranking each of the sets based upon corresponding at least one scores.

13. The apparatus of claim 12, wherein selecting further comprises selecting those sets having corresponding at least one scores meeting a predetermined criterion.

14. The apparatus of claim 9, wherein the at least one heuristic comprises at least one of 1−\sqrt{n}(1−p1)(1−p2) . . . (1−pn), 1−\sqrt{n/N}(1−p1)(1−p2) . . . (1−pn), mean(p1, p2, . . . pn), or median(p1, p2, . . . , pn), where n is a number of passages for a particular set, p1 is a confidence level for passage 1, p2 is the confidence level for passage 2, . . . , and pn is a confidence level for passage n, and N is the total number of passages.

15. The apparatus of claim 9, wherein the identifications identify associated ones of the vehicles.

16. A computer readable medium tangibly embodying a program of machine-readable instructions executable by a digital processing apparatus to perform operations comprising:
for a set of passages of a vehicle, where each passage is associated with at least one confidence level, applying at least one heuristic to confidence levels corresponding to the set to determine at least one score;
performing the applying at least one heuristic for a plurality of sets of passages of a plurality of vehicles;
selecting a number of the sets based on their associated at least one scores; and
outputting identifications corresponding to each of the selected sets.

17. The computer readable medium of claim 16, wherein at least one passage for a vehicle is a passage through a gantry.

18. The computer readable medium of claim 16, wherein the at least one confidence level for at least one of the passage corresponds to an automatic number plate recognition observation.
